(19) United States
(12) Patent Application Publication
(10) Pub. No.: US 2012/0144677 A1
(43) Pub. Date: Jun. 14, 2012

(54) FOLDING KNIFE

(76) Inventor: WU-CHIEH CHANG, Taichung City (TW)

(21) Appl. No.: 12/963,605

(22) Filed: Dec. 8, 2010

(51) Int. Cl. B26B 1/04

(52) U.S. Cl. 30/161

(57) ABSTRACT

A folding knife that is assisted by a spring force in extending a blade thereof provides an effortless and safe structure of folding knife. The folding knife includes opposite handle plates and clamp plates that clamp a blade therebetween. The blade has a surface forming a raised portion that defines a cam ring having a caroming contour surrounding a pivot hole of the blade. The cam ring is received in a hollow opening formed by stamping one of the clamp plates to be engageable with a spring arm arranged in the opening. The camming contour and the resilience of the spring arm help realizing effortless and resiliency-assisted extension of the blade. The other clamp plate forms a slot that defines a resilient sideway-deflected positioning plate engageable and thus retaining the blade at an extended position. Advantages of effortless extension of blade and operation safety by the blade can be achieved.

### TECHNICAL FIELD OF THE INVENTION

The present invention generally relates to an improvement of folding knife, which comprises clamp plates, which are arranged at inner sides of handle plates and stamped to form a slot and an opening respectively for providing resilient parts that ensure effortless and fast expansion of the folding knife and assisted safety positioning for cutting operation, whereby with the resilient parts of the clamp plates that are respectively formed as a spring arm and a resilient positioning plate, the structure of the folding knife is greatly simplified and the volume reduced so as to achieve a design purpose of easy holding and carrying.

### DESCRIPTION OF THE PRIOR ART

A spring-operated folding knife is often constructed in consideration of light weight and easy use and structurally comprises an assisting component of spring or the likes in order to realize easy spring-out of the blade under a simple push. To provide a design that allows for fast expansion or extension of the blade, the conventional folding knife is often comprised of a complicated internal structure. Further, in order to add certain assisting spring accessory, the overall size of the folding knife must be expanded. Due to the increased number of parts, the manufacture gets complicated and the total cost increased. The bulkiness of size also negatively affects the dexterousness of operation. Thus, it is desired to make the structure of the conventional folding knife simple in order to meet the needs for practicability, easiness, and safety so that the structure of the conventional folding knife needs to be further improved.

### SUMMARY OF THE INVENTION

In view of the above discussed problems related to the use and manufacture of the conventional spring-operated folding knife, the present invention aims to provide an improved folding knife, which comprises clamp plates, which are respectively set at inside surfaces of opposing handle plates and are respectively formed with a resilient positioning plate and a spring arm for retention purposes, so as to achieve the effectiveness of being effortless in extending a blade and providing an assistance to ensure effective and reliable positioning, whereby the structure of the knife is made simple and the operation effortless and the drawbacks of not meeting the needs for safety and practicability found in the manufacture and use of the conventional folding knife.

The improvement of the present invention is that clamp plates are arranged at inner sides of opposite handle plates of a folding knife. The clamp plates are machined through stamping or pressing to respectively form a resilient positioning plate and a spring arm, which is engageable with a cam ring that is raised on a surface of a blade and forms a curved camming contour to realize effortless and fast extension of the blade. Further, the positioning plate serves to selectively engage and thus retain the blade in the extended position to ensure safety of use of the knife. The structure and assembling of the whole knife are greatly simplified and a practicable advantage of effortless and fast ejection or extension of the blade. As such, the folding knife of the present invention satisfies multiple design purposes of safe operation, reduction of manufacturing cost, and easiness of assembling.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a folding knife according to the present invention.

FIG. 2 is a perspective view showing the folding knife of the present invention in an extending, operation condition.

FIG. 3 is a perspective view showing the folding knife of the present invention in a folded condition.

FIG. 4 is a schematic side elevational view showing the folding knife of the present invention in the folded condition.

FIG. 5 is a schematic side elevational view showing the folding knife of the present invention in the extending condition.

FIG. 6 is a top plan view showing the folding knife of the present invention in the extending condition.

FIG. 7 is a side elevational view showing a folding operation of the folding knife of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

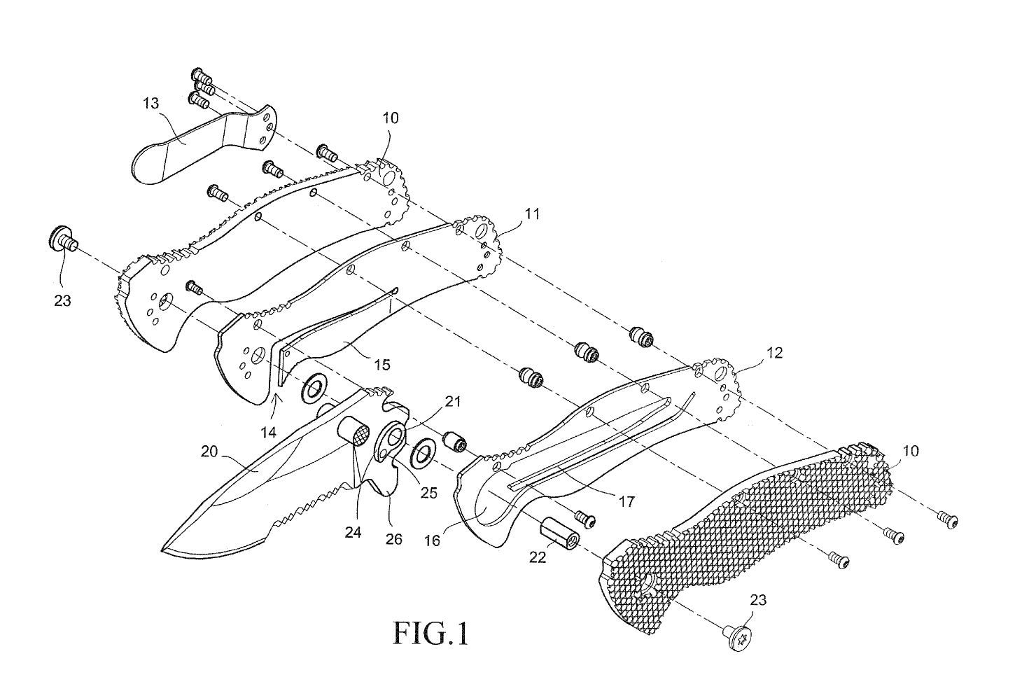

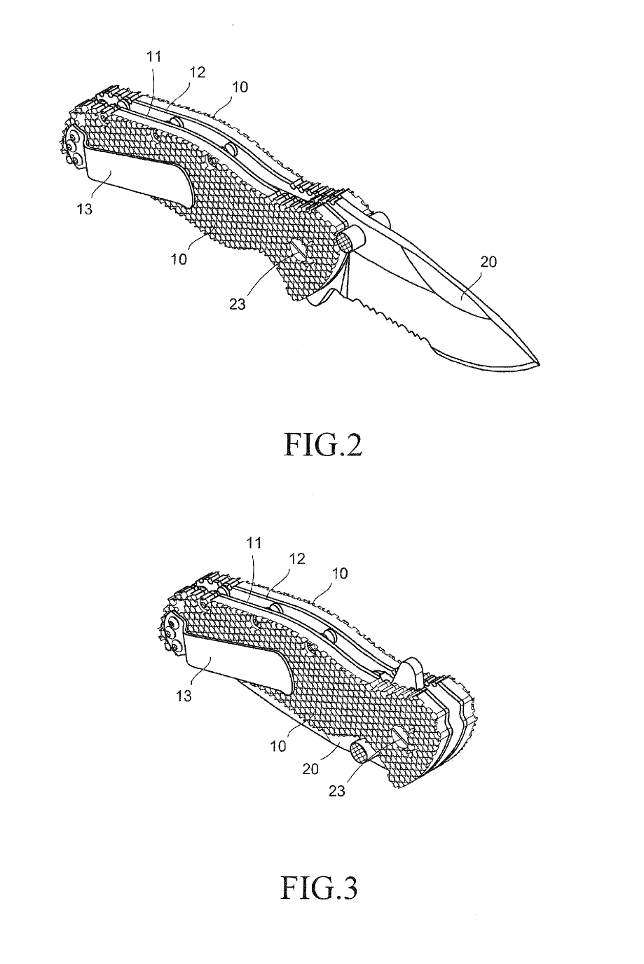

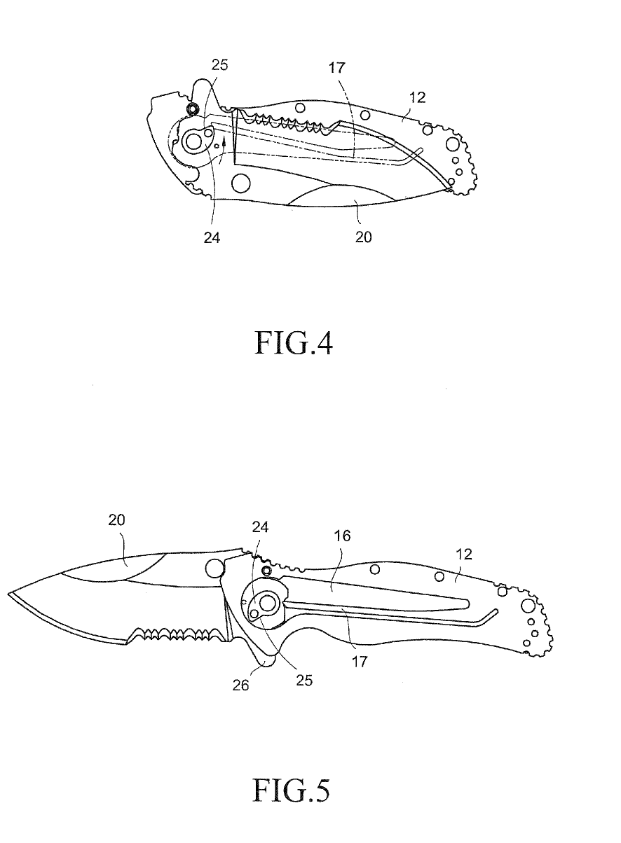

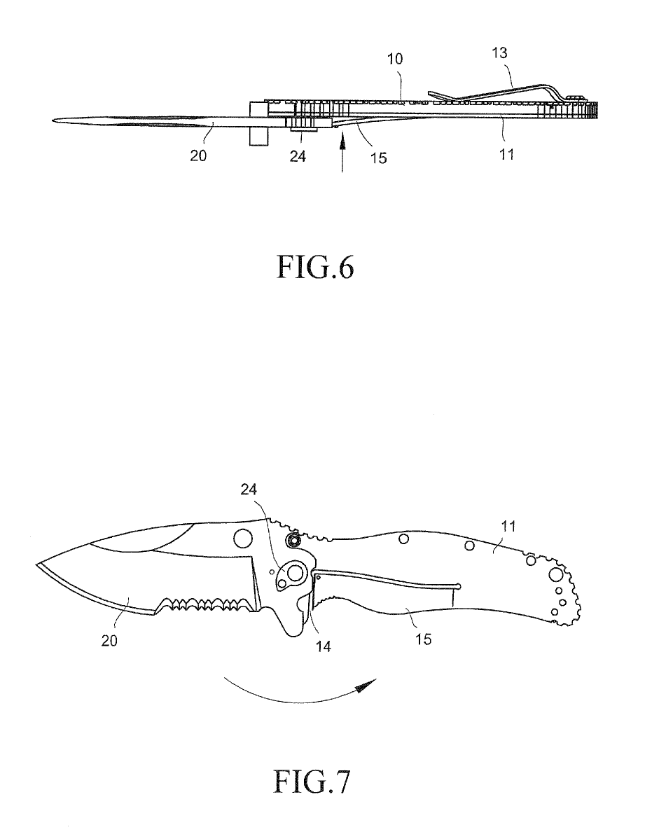

Referring to FIGS. 1-7, the present invention provides a folding knife, which comprises handle plates 10 that are fastened to each other to be held by a user's hand and internal clamp plates 11, 12 that are located between the handle plates 10 and are opposite to each other to receive and retain a blade 20 therebetween. A spring clip 13 is mounted to an outside surface of one of the handles 10 for easy carrying of the folding knife by ready insertion and clipping. One clamp plate 11 located between the handle plates 10 has a bottom edge that forms a cut slot 14 that separates a portion of material of the clamp plate 11 from the remaining portion to define a resilient positioning plate 15 that extends in an inclined fashion and is elastically and inwardly deflectable in a sideways direction with respect to the clamp plate 11. The other, opposite clamp plate 12 forms a hollow central portion, which is formed by stamping the clamp plate 12 as an opening 16 extending from a location close to a pivotal joint (which will be further described) toward an opposite end with an elongate spring arm 17, preferably in a cantilevered fashion, extending in the opening 16 to have a free end located close to the pivotal joint. The blade 20 is interposed between the two clamp plates 11, 12. A pivot hole 21 is formed in an end of the blade 20 for receiving a pivot pin 22 to extend therethrough for fastening, together with fasteners 23 fastened thereto, all of the components of the folding knife between the two handle plates 10. On one surface of the blade 20, a raised portion is formed, preferably surrounding the pivot hole 21, to serve as a cam 24, which is in the form of an irregular ring having a curved circumference defining a camming contour surrounding the pivot hole 21 as in the embodiment illustrated. The cam ring, which is raised from the surface of the blade, is accommodated in the opening 16 of the clamp plate 12 so that the curved circumference of cam contour is engageable with the spring arm 17. The contour of the cam ring 24 has a maximum radius point, where a step 25, extending substantially in the radial direction, is defined to engage the free end of the spring arm 17 when the blade 20 is folded into the handle and thus elastically deform the spring arm 17, as illustrated in FIG. 4. In this way, a potential energy caused by the deformation is accumulated in the spring arm, whereby when the blade 20 is opened, a slight movement of the blade 20 to pass the step 25 of the cam ring 24 in a direction going out of the handle by applying a small force to an operating tab 26 that extends out of the handle is sufficient to allow the spring force to help driving the blade 20 to open in a fast manner. When the blade 20 is opened and moved to a position substantially at an angular position of around 180 degrees with respect o the handle plates 10, the positioning plate 15 of the clamp plate 11, due to the resiliency thereof, is allowed to deflect sideways in a direction away from the clamp plate 11 to engage the end of the blade 20, as shown in FIGS. 6 and 7, serving as an assisting positioning measure that helps retaining the blade in the extended position and allowing cutting operation to be soundly and safely performed by the blade. To fold the blade 20 again, the positioning plate 15 is depressed toward the clamp plate 11 for retraction, thereby releasing the blade 20 to be folded. Due to the resiliency of the positioning plate 15 of the clamp plate 11 that applies a sideways spring force acting on a surface of the blade and also due to the engagement of the spring arm 17 of the clamp plate 12 with the camming contour of the cam 24 that applies a force to the cam 24, the folding of the blade 20 can be performed in a smooth, slow, and safe manner and when the blade 20 reaches the most inward position for storage, the spring arm 17 engages and applies a pushing force to the maximum radius point of the camming contour of the cam ring 24 to ensure secured positioning and storage of the blade. As such, extending the blade can be operated in an effort-reduced manner and the folding of the blade can be made secured and firm.

The improvement of the present invention is that the clamp plates 11, 12 that are interposed between the handle plates 10 are respectively provided with the positioning plate 11 and the spring arm 17. The spring arm 17 cooperates with the camming contour of the cam ring 24 that is raised on a surface of the pivotally jointed blade 20 so as to provide an assisting force in opening or extending of the blade 20 thereby making extending or opening of the blade 20 efficient and fast. The positioning plate 15 is set to resiliently engage an opposite surface of the blade 20 and functions to securely position the blade 20 after the extending of the blade 20 thereby achieving operation safety of the folding knife. In folding the blade, with the sideways force applied by the positioning plate 15 to said opposite surface of the blade 20, the folding of the blade 20 is made smooth and reliable and at the folded position of the blade, the spring arm 17 engages and applies a force to the maximum radius point of the camming contour of the cam ring 24 to ensure safe and secured positioning for the folded blade. In this way, the construction of the folding knife is greatly simplified and with the clamp plates 11, 12 located on opposite sides of the blade to realize resilient clamping and retention for achieving different functionalities, the assembling of the folding knife is easy, the manufacture is efficient, and the use is safe. Consequently, the manufacture cost is reduced and overall volume is also reduced to ensure easy and reliable holding and carrying.

In summary, the present invention provides a folding knife that comprises two handle plates inside which features for resilient clamping and retention are respectively provided to ensure safe and reliable operation of extending and operating of the knife and to greatly simplify the construction and assembling.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A folding knife comprising a blade and two handle plates on opposite sides to pivotally mount the blade between the handle plates through a pivot pin cooperating with a fastener to form the folding knife, characterized in that clamp plates are respectively received inside the handle plates, one of the clamp plates having a bottom in which a cut slot is formed to define a resilient positioning plate that is inclined sideways with respect to the clamp plate, the other one of the clamp plates forming a central hollow opening and a spring arm extending in the opening, the blade forming a pivot hole and also forming a cam ring raised on a surface of the blade to surround the pivot hole, the cam ring forming a camming contour that is accommodated in the hollow opening in a rotatable manner, the spring arm having a free end engageable with the camming contour of the cam ring and following the camming contour when the blade is rotated, to provide a pushing force for extending of the blade and to provide assisted positioning for folding of the blade, whereby the extending of the blade is made efficient and effortless and the folding of the blade is secured and safely positioned.

2. The folding knife according to claim 1, wherein the camming contour of the cam ring has a maximum radius point where a step is formed.

3. The folding knife according to claim 1, wherein the positioning plate that is defined by a cut slot in a bottom of said one of the clamp plates is resiliently deflected sideways to engage an end of the blade for positioning of the blade after the blade is extended, thereby achieving assisted positioning of the extended blade.

4. The folding knife according to claim 1, wherein one of the handle plates comprises a spring clip mounted to an outside surface thereof.
